(19) United States
(12) Patent Application Publication
(10) Pub. No.: US 2012/0280013 A1
(43) Pub. Date: Nov. 8, 2012

(54) GPS HOLDING DEVICE

(76) Inventors: Franklin Carter, Harrisburg, PA (US); Anna Carter, Harrisburg, PA (US)

(21) Appl. No.: 13/103,020

(22) Filed: May 6, 2011

(51) Int. Cl. B62J 11/00; B62K 11/00

(52) U.S. Cl. 224/413

(57) ABSTRACT

The present invention is a GPS holding device for a motorcycle that includes a generally rectangular base with a tab and an aperture disposed on the tab, a bracket with a tab and an aperture disposed on the tab to secure the base to the device and a fastener that is placed through the apertures to secure the bracket to the base. The device is made of metal and has a powder coating covering the base and the bracket and a protective case to cover and protect the device. The holding device can also be used to secure a cell phone.

### TECHNICAL FIELD & BACKGROUND

Although GPS systems were first introduced as primarily automobile accessories, they have now expanded tremendously and can even be found as applications on many mobile phones. Currently there is a very limited selection of GPS mounts that are safe and suitable for use on a motorcycle.

The present invention generally relates to a holding device. More specifically, the invention is a GPS holding device for a motorcycle.

It is an object of the invention to provide a GPS holding device that serves as a motorcycle mount to secure a GPS device in front of a motorcycle rider while the rider is riding the motorcycle.

It is an object of the invention to provide a GPS holding device that is easily adjustable and will accommodate GPS systems or cell phones in a wide variety of sizes.

What is really needed is a GPS holding device that serves as a motorcycle mount to secure a GPS device in front of a motorcycle rider while the rider is riding the motorcycle that is easily adjustable and will accommodate GPS systems or cell phones in a wide variety of sizes.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side perspective view of a GPS holding device and its components, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

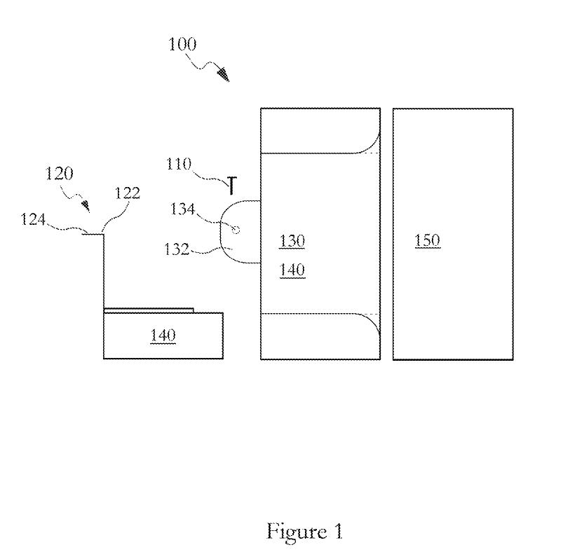

FIG. 1 illustrates a side perspective view of a GPS holding device 100, in accordance with one embodiment of the present invention. The GPS holding device 100 includes a fastener 110, a bracket 120, a generally rectangular base 130, a powder coating 140 and a protective case 150. The GPS holding device 100 is utilized to mount a GPS device or a cell phone (both not shown) to a motorcycle or other suitable object, device or machine.

The fastener 110 is utilized to attach the generally rectangular base 130 to the bracket 120 and can be a screw, a bolt, a rivet or other suitable fastener. The bracket 120 includes a tab 122 with an aperture 124 that is utilized to attach the GPS holding device 100 to a motorcycle or other suitable object, device or machine. The generally rectangular base 130 includes a tab 132 with an aperture 134 on the tab 132 to accommodate a screw 110 or other suitable fastener, to hold and secure the GPS device or cell phone to the GPS holding device 100. The powder coating 140 provides a protective coating to the generally rectangular base 130 and the bracket 120. The protective case 150 is weatherproof and water-resistant to protect the GPS holding device 100 from outside elements and conditions.

The GPS holding device functions like a traditional mount with the additional benefit of optimal placement and can be positioned directly in front of the driver in order to allow the driver to easily see the road at all times. The GPS holding device 100 is made from sturdy sheet metal and includes a weatherproof case that is water-resistant to protect the GPS holding device from outside elements and conditions. The GPS holding device includes adjustable features that will accommodate GPS systems or cell phones of varying sizes and is compatible with most GPS makes and models. The GPS holding device is made of sheet metal that is approximately 5-112 inches wide, 112 inch deep and 3 inches tall that is supported by a bracket that is approximately 3 inches in height.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A GPS holding device, comprising:
a generally rectangular base with a tab and an aperture disposed on said tab;
a bracket with a tab and an aperture disposed on said tab to secure said base to device;
a fastener that is placed through said apertures to secure said bracket to said base; and
a powder coating covering said base and said bracket.

2. The device according to claim 1, wherein said base is made of metal.

3. The device according to claim 1, wherein said bracket is made of metal.

4. The device according to claim 1, wherein said fastener is a screw, a bolt or a rivet.

5. The device according to claim 1, wherein said device secures a cell phone.

6. The device according to claim 1, wherein said device is secured to a motorcycle.

7. A GPS holding device, comprising:
a generally rectangular base with a tab and an aperture disposed on said tab;
a bracket with a tab and an aperture disposed on said tab to secure said base to device;
a fastener that is placed through sad apertures to secure said bracket to said base;
a powder coating covering said base and said bracket; and
a protective case to cover and protect said device.

8. The device according to claim 7, wherein said base is made of metal.

9. The device according to claim 7, wherein said bracket is made of metal.

10. The device according to claim 7, wherein said fastener is a screw, a bolt or a rivet.

11. The device according to claim 7, wherein said device secures a cell phone.

12. The device according to claim 7, wherein said device is secured to a motorcycle.

13. A GPS holding device, comprising:
a generally rectangular base with a tab and an aperture disposed on said tab;
a bracket with a tab and an aperture disposed on said tab to secure said base to device;
a fastener that is placed through said apertures to secure said bracket to said base;
a powder coating covering said base and said bracket; and
a protective case to cover and protect said device.

14. The device according to claim 13, wherein said base is made of metal,

15. The device according to claim 13, wherein said bracket is made of metal.

16. The device according to claim 13, wherein said fastener is a screw, a bolt or a rivet,

17. The device according to claim 13, wherein said device secures a cell phone.

18. The device according to claim 13, wherein said device is secured to a motorcycle,

19. The device according to claim 13, wherein said device is approximately 5½ inches wide, ½ inch deep and 3 inches tall.

20. The device according to claim 13, wherein said bracket is approximately 3 inches in height.
